(19) United States
(12) Patent Application Publication
(10) Pub. No.: US 2010/0272300 A1
(43) Pub. Date: Oct. 28, 2010

(54) DEVICE FOR HOLDING VEHICLE SENSORS

(75) Inventors: Patrick Schlitt, Schlitz (DE); Wilhelm Beer, Russelsheim (DE)

Correspondence Address: RATNERPRESTIA, P.O. BOX 980, VALLEY FORGE, PA, 19482, US

(73) Assignee: Continental Teves AG & Co. oHG, Frankfurt (DE)

(21) Appl. No.: 12/668,095

(22) PCT Filed: Jul. 10, 2008
(86) PCT No.: PCT/EP08/59030

§ 371 Date: Jun. 4, 2010

(30) Foreign Application Priority Data
Jul. 10, 2007 (DE) 10 2007 032 420.2
Jul. 10, 2008 (DE) 10 2008 032 400.0

(51) Int. Cl. H04R 1/02; B60R 7/00

(52) U.S. Cl. 381/334; 224/282

(57) ABSTRACT

A device for holding vehicle sensors in a vehicle, wherein the device includes a housing, at least one holder for mobile terminals, wherein the first holder for mobile terminals is designed such that the mobile terminals are affixed to the housing via the holder by a releasable connection, and the holder, which includes a ball, is connected to the housing by a ball socket. An inside mirror of the vehicle is affixed to a holder arm which is rotatably connected to the housing, and the housing has an installation space for holding sensors, provisions for communication, provisions for position determination, and actuation provisions for making calls.

### CROSS REFERENCE TO RELATED APPLICATIONS

This application is the U.S. national phase application of PCT International Application No. PCT/EP2008/059030, filed Jul. 10, 2008, which claims priority to German Patent Application No. 10 2007 032 420.2, filed Jul. 10, 2007 and German Patent Application No. 10 2008 032 400.0, filed Jul. 10, 2008, the contents of such applications being incorporated by reference herein.

### BACKGROUND OF THE INVENTION

1. Field of the Invention

The invention refers to a device for holding vehicle sensors.

2. Description of the Related Art Several sensors are known which serve to increase driving safety, e.g. optical scanning devices including a line from opto-electrical converters (e.g. CCD array), among others. Such a vehicle comprising an optical scanning device for a lateral area of the road has been disclosed in DE 195 07 957 C1A1, which is incorporated by reference. In conjunction with an evaluation unit which is connected downstream thereof, this scanning device serves to warn the driver that he/she might be falling asleep, to implement an automatic track keeping function, or to monitor the rear of the passenger compartment or the vehicle's surroundings.

A roll-over detection device known from DE 102 04 128 A1, which is incorporated by reference, includes a stereo camera which is oriented in the direction of driving, whereby the distance to an object located outside the vehicle can be measured and image vectors concerning this object are determined in each case. This known device has a rather complex structure, in particular due to the stereo camera.

Inside mirrors mostly only make sense in vehicles in which the occupants are allowed to see through to the vehicle's rear, i.e. mainly in motor vehicles. Busses are also equipped with inside mirrors, which serve, however, to observe the passengers. In motor vehicles, the inside mirrors are mounted on a ball-and-socket joint which is affixed to the windscreen in the middle between the driver's and the front passenger's seats so that the inside, mirror can be adjusted to the individual needs of the driver. Today, most of these mirrors are day/night mirrors to avoid the driver from being blinded by glare from following vehicles during darkness, i.e. they are tilted to a position in which a second, darker mirror becomes effective without changing the field of view. In auto-dimming inside or outside mirrors, a sensor detects the level of brightness emitted by a vehicle whose lights blind the driver and dims the mirror glass.

### SUMMARY OF THE INVENTION

An object of the invention is to provide a device which is able to hold vehicle sensors and can be flexibly installed in different vehicles.

In an advantageous embodiment of the invention, the inventive device includes a housing (110) comprising at least one holder for mobile terminals (120), which holder for mobile terminals (120) is designed such that said mobile terminals are affixed to the housing (110) via said holder (120) by means of a releasable connection (200), and said holder, which comprises a ball, is connected to said housing (110) by means of a ball socket (50), and an inside mirror (150) of the vehicle is affixed by means of a fastening screw (60) to the housing (110) on a holder arm (140) which is rotatably connected to said housing, and said housing has an installation space (115) for holding sensors, means for communication, means for position determination, and actuation means for making calls.

In another advantageous embodiment, the housing comprises a loudspeaker (10) and a microphone (40) for hands-free talking, which are connected via a wired communication link to means for communication that are affixed at the bottom (230) of the installation space (115) in a releasable and/or plug-in manner, which means for communication are a GSM module and/or a GPRS module and/or a UMTS module and/or a Bluetooth module and/or a WLAN module and/or a DSRC module and/or a DVB-T module.

In another advantageous embodiment of the device, the means for position determination are affixed in the bottom (230) of the installation space (115) in a releasable and/or fixable manner, said means for position determination being receivers for evaluating satellite signals and/or radio transmitter signals and said means for position determination being a GPS module and/or a GLOSNASS module and/or a COMPASS module and/or a Galileo module and/or an IRNSS module and/or an EGNOS module and/or a GAGAN module and/or a MEAS module and/or a WASS module.

In another advantageous embodiment of the device, visual sensors are arranged in the installation space (115), above and/or next to and/or below the means for communication and position determination.

In another advantageous embodiment, the device comprises a unit which is arranged to hold at least one visual sensor in the installation space (115), above and/or next to and/or below the means for communication and the means for position determination, which unit for holding at least one visual sensor is supported (190) so as to be rotatable and/or variable in height and/or adjustable.

In an advantageous embodiment, at least one switch (20) is arranged on the housing (110), which switch is designed as an actuation element for making an emergency call.

It is particularly advantageous if the housing (110) is made of plastic and/or aluminium and/or sheet metal. As an alternative, the housing is made by deep-drawing. Furthermore, the housing (110) can be made of a composite material.

In another advantageous embodiment, the housing (110) is affixed to a windscreen by gluing the lip (90) thereon.

In another advantageous embodiment, the housing (110) is designed as a telescopic housing.

Thanks to the flexible and variable installation, the invention provides a device which allows the sensors to be positioned variably and to adapt their positions easily, independent of the position of the windscreen and the manner in which it is supported.

In another advantageous embodiment of the invention, a wireless radio link is established by means of short-range communication. It is particularly advantageous that said short-range communication is achieved using a Bluetooth module and/or Ultra Wide Band technology (UWB), thus cross-linking all terminals arranged within the vehicle in a piconet.

### BRIEF DESCRIPTION OF THE DRAWINGS

An exemplary embodiment of the invention is shown in the drawings and will be described in detail below.

In the drawings,

FIG. 1 shows a plan view of the device,

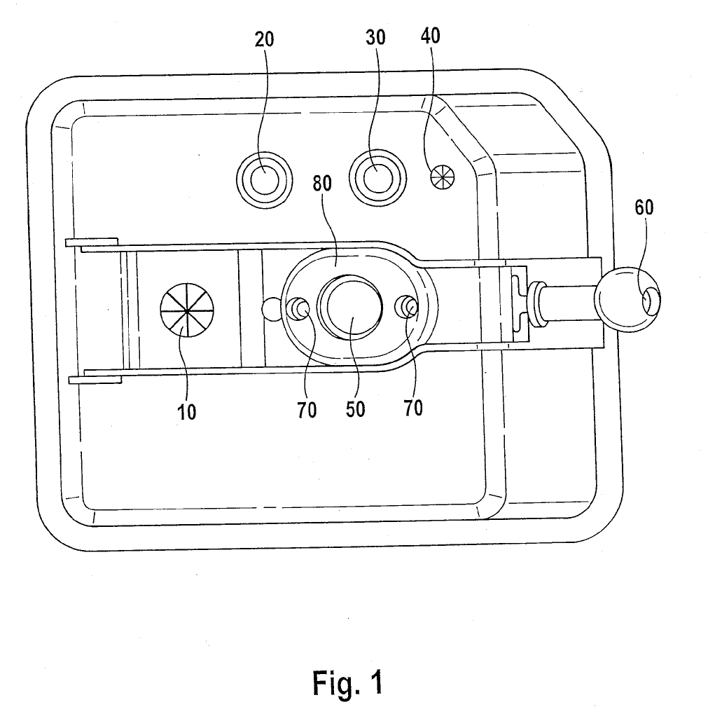

FIG. 2 shows a side view of the device,

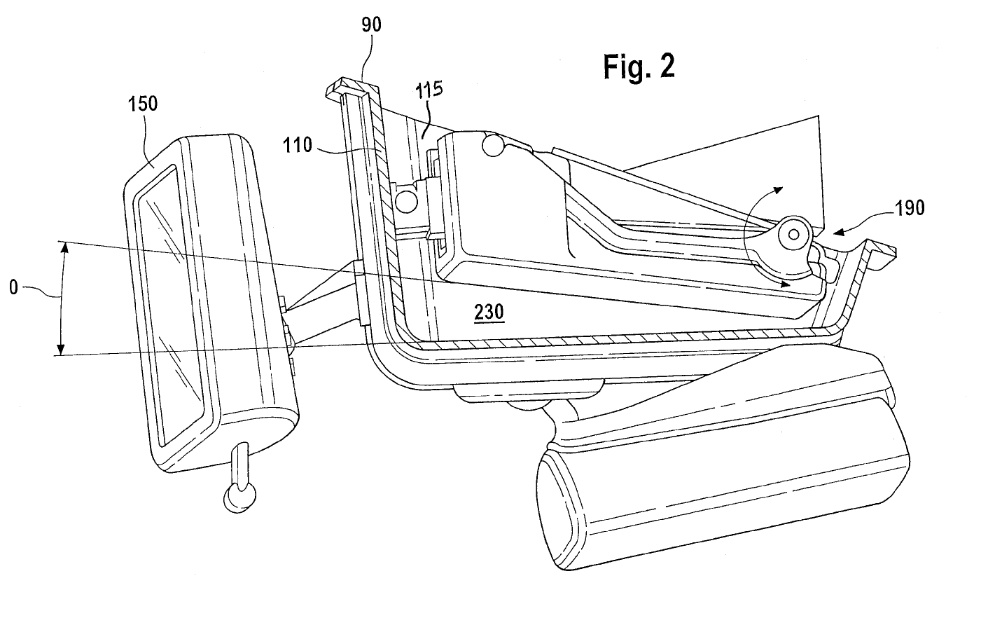

FIG. 3 shows a view of the installation space,

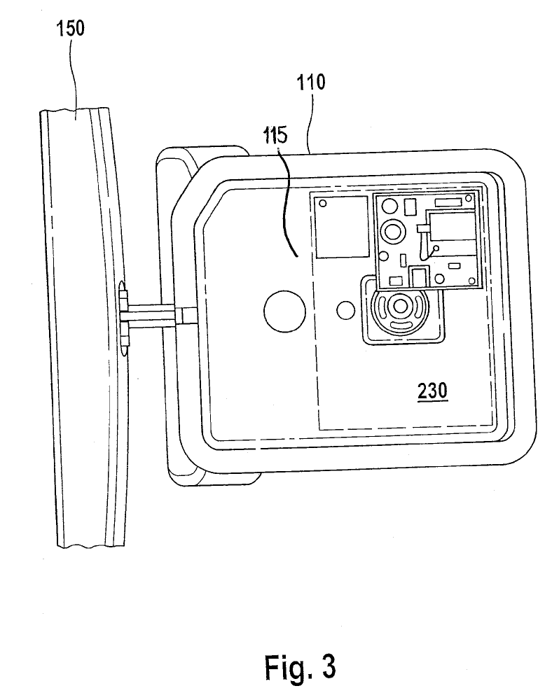

FIG. 4 shows an overall view of the device,

FIG. 5 shows an overall rear view,

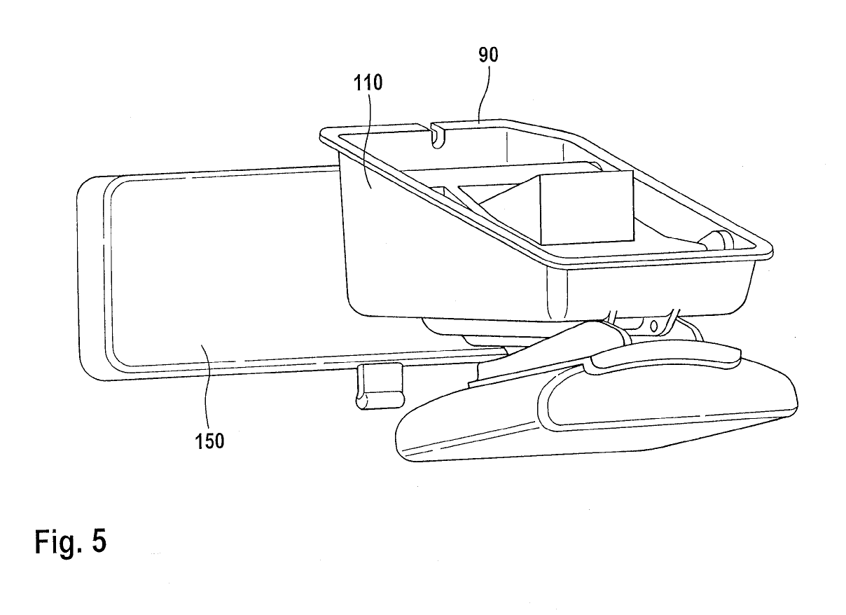

FIG. 6 shows a plan view including a visual sensor which has been installed,

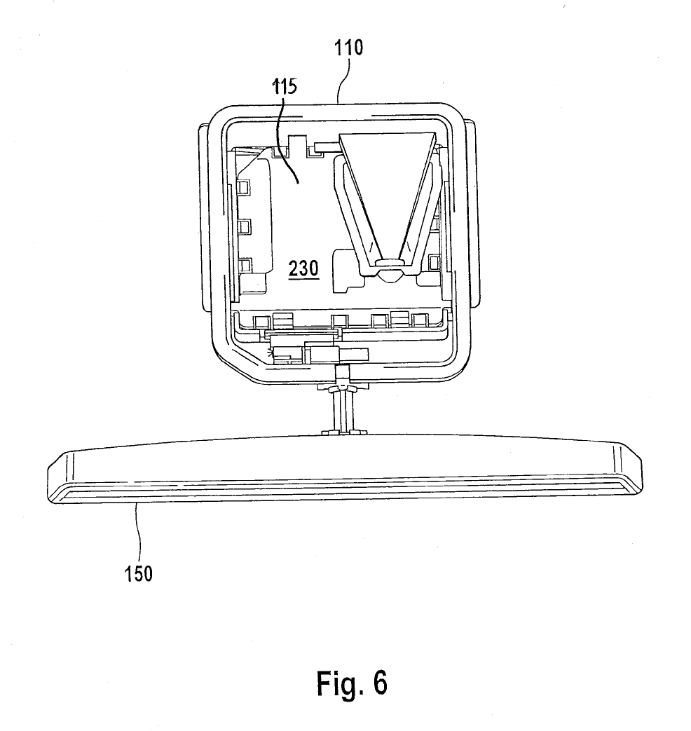

FIG. 7 shows a side view including a visual sensor which has been installed.

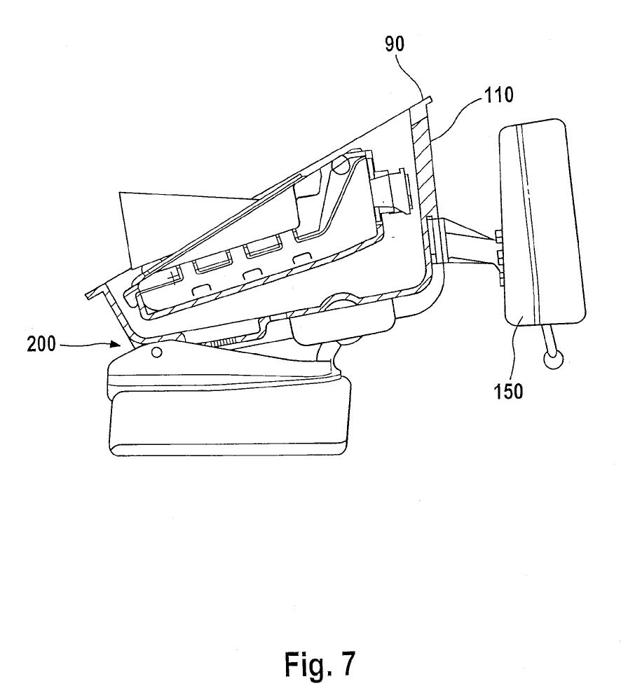

### DETAILED DESCRIPTION OF THE PREFERRED EMBODIMENTS

The camera or the camera housing is supported in the housing (110) so as to be movable, wherein said movable support is designed such that the angle of inclination of the camera (100) can be varied. In a simple embodiment, an adjustment screw is provided in the housing (110), which is adjusted during assembly.

In another embodiment, the adjustment screw (190) is provided on the shaft of an electric motor, preferably a stepper motor, and adjustment is done online based on information determined in the vehicle. In this way, deviations caused by the running time of the vehicle are compensated without removing the housing (110) from the windscreen.

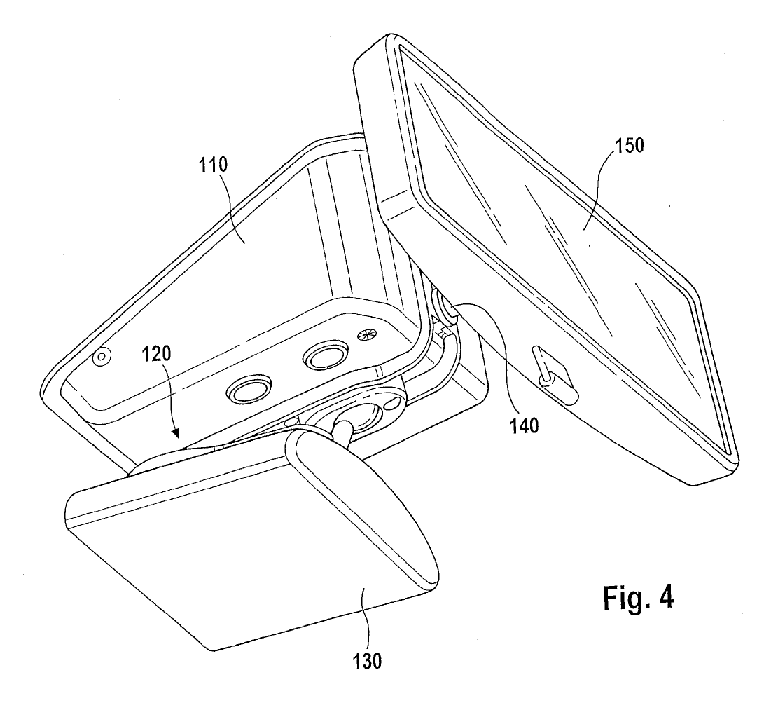

A holder (120) is affixed to the housing, which can hold mobile terminals, such as a mini notebook, smartphone, MDA, PDA, or a navigation system. The holder is supported in the ball socket (50) so as to be rotatable. Said support in the ball socket is designed such that the accelerating forces acting during a braking process guide the mobile terminal to assume a locked position, as indicated in FIG. 4. This guided movement is independent of the current orientation or position of the mobile terminals.

The electrical components, such as the means for communication, the means for position determination, are arranged in the housing below said camera.

A particular advantage is the fact that the device can be installed variably and adapted to different windscreens which are installed in the vehicle at different angles of inclination. The mirror and the navigation system are affixed to the housing via joints and can still be oriented.

The components of the housing are made of plastic. They can, however, also be manufactured from sheet metal (deep-drawing) or from a composite material (CFRP, GFRP).

The entire device is affixed to the windscreen via a flexible lip by gluing, e.g. using an adhesive tape.

In another embodiment, the housing is designed in two parts with the mounting frame and the housing as such. For this purpose, the frame is placed centrally on the windscreen and fixed. Subsequently, the housing including the sensors is affixed to said frame using fastening elements, such as screws or a clip-on system. In the two-part design of the housing, it is contemplated to place the housing and the frame by means of a plug-in system and/or screwing in order to affix them to the windscreen.

In another embodiment, the housing has a rectangular shape, thus enabling attachment to the inside roof lining, whereby the installation space will then be block-shaped and the housing or the housing walls will be equal in height.

To achieve an optimum position, the angle of inclination of the camera is advantageously changed via an adjustment screw which is preferably mounted on a shaft of an electric motor, which electric motor is installed in the installation space. The device according to the invention can be adapted to and affixed variably in any place on the upper and lower edges of different types of windscreens. According to aspects of the invention, it is contemplated that the angle of inclination of the camera, which is adjusted dynamically via an electric motor by means of a learning procedure, is adapted automatically according to the surface quality of the road and the physical state of the road to maintain an optimum orientation at any time.

1.-14. (canceled)

15. A device for holding vehicle sensors in a vehicle comprising:
a housing,
at least one holder for mobile terminals, wherein said holder for mobile terminals is configured such that said mobile terminals are affixed to the housing via said holder by a releasable connection; and
said holder, which comprises a ball, is connected to said housing by a ball socket;
an inside mirror of the vehicle is affixed to a holder arm which is rotatably connected to said housing; and
said housing defines an installation space for holding sensors, means for communication, means for position determination, and/or actuation means for making calls.

16. A device according to claim 15, wherein the housing includes a loudspeaker and a microphone for hands-free talking, which are connected via a wired communication link to means for communication that are affixed at a bottom of the installation space in a releasable and/or plug-in manner.

17. A device according to claim 15, wherein means for position determination are affixed in a bottom of the installation space in a releasable and/or fixable manner.

18. A device according to claim 16, wherein means for communication are a GSM module, a GPRS module, a UMTS module, a Bluetooth module, a WLAN module, a DSRC module, a DVB-T module or any combination thereof.

19. A device according to claim 15, wherein means for position determination are receivers for evaluating satellite signals and/or radio transmitter signals.

20. A device according to claim 15, wherein means for position determination are a GPS module, a GLOSNASS module, a COMPASS module, a Galileo module, an IRNSS module, an EGNOS module, a GAGAN module, a MEAS module, a WASS module or any combination thereof.

21. A device according to claim 15, wherein visual sensors are arranged in the installation space, above and/or adjacent and/or below the means for communication and the means for position determination.

22. A device according to claim 15, wherein a unit for holding at least one visual sensor is arranged in the installation space, above and/or adjacent and/or below the means for communication and the means for position determination, and said unit for holding at least one visual sensor is rotatable, variable in height, and adjustable.

23. A device according to claim 15, wherein at least one switch is arranged on said housing, wherein said switch is designed as an actuation element for making an emergency call.

24. A device according to claim 15, wherein the housing is composed of plastic, aluminium, sheet metal or any combination thereof.

25. A device according to claim 15, wherein the housing is formed by deep-drawing.

26. A device according to claim 15, wherein the housing is composed of a composite material.

27. A device according to claim 15, wherein the housing is affixed to a windscreen by gluing a lip thereon.

28. A device according to claim 15, wherein the housing is designed as a telescopic housing.
